(19) United States
(12) Patent Application Publication
(10) Pub. No.: US 2010/0180707 A1
(43) Pub. Date: Jul. 22, 2010

(54) Rolling Element Screw

(76) Inventor: Wen-Chia WU, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/356,047

(22) Filed: Jan. 19, 2009

(51) Int. Cl. F16H 25/22; F16C 29/06

(52) U.S. Cl. 74/424.87

(57) ABSTRACT

A rolling element screw comprises a screw and a nut mounted on the screw. The screw and the nut are defined with opposite rolling grooves to form a loaded path in which plural rolling elements are to be disposed. The nut is provided with a return element at each of two opposite ends thereof for cooperating with the loaded path. The respective return elements include a return path, and the return paths of the two return elements connect with the loaded path to form a circulation path. The junction where the respective return paths of the return elements are connected to the loaded path is designed to be an inclined surface including a lower portion and an upper portion. There is a height difference between the nut rolling grooves and the respective return paths, so that the rolling elements can roll more smoothly without causing the jammed problem.

### BACKGROUND OF THE INVENTION

1. Field of the Invention

The present invention relates to a rolling element screw which is applied for linear transmission; and more particularly to a rolling element screw which has a height difference between the respective return paths and the nut rolling groove for making the rolling elements circulate more smoothly without causing the jammed problem.

2. Description of the Prior Art

As for designs of controlling the movement of tables or processing elements in the precision machines, in order to control the feed amount precisely with low friction coefficient, a ball screw is commonly used for transmission. The ball screw is provided with a screw and a nut. In order to reduce the friction, the ball screw is further provided with a plurality of balls or rollers between the screw and the nut. The balls or roller must be able to circularly roll in the nut. The screw is defined with a rolling groove while the nut is also defined with a rolling groove, and the rolling grooves of the screw and nut cooperate with each other to define a loaded path. The nut is provided with a return element at each of two opposite ends thereof, and each of the return elements includes a return path. The return paths are connected to the loaded path to define a circulation path for the balls or rollers. Due to the errors in manufacturing and assembly, sectional difference is likely to occur on the junctions of the circulation path, so that when the balls or rollers pass the junctions where the sectional difference is from low to high, the rolling process is relatively unsmooth, or even the balls or rollers are possibly jammed.

### SUMMARY OF THE INVENTION

The technical problems to be solved:

Conventionally, the balls or rollers circulate within a circulation path which is defined by connecting a loaded path defined by two opposite rolling grooves with two return paths, due to the errors in manufacturing and assembly, sectional differences inevitably occur on junctions within the circulation path, if the sectional differences make the balls or rollers roll from low to high, unsmooth rolling will be caused, or even the balls or rollers will be jammed within the circulation path.

In order to solve the above technical problems, a rolling element screw in accordance with the present invention comprises:

A screw is provided with a screw rolling groove in a periphery thereof.

A nut is provided with an insertion hole for insertion of the screw and a nut rolling groove in an inner surface of the insertion hole, the nut rolling groove is located opposite the screw rolling groove, so that the nut rolling groove can cooperate with the screw rolling groove to define a loaded path, the nut is further provided with a recess in each of two opposite ends thereof and a rolling passage between the two recesses, the recesses are connected to the loaded path, respectively.

Plural rolling elements roll within the loaded path.

Two return elements are installed in the recesses of the nut, respectively, each of the two return elements includes a return path, and one end of the respective return paths is connected to the loaded path, and the other end of the respective return paths being connected to each other.

A junction where the nut rolling groove is connected to the respective return paths of the return elements is designed to be an inclined surface in such a manner that the return path is higher than the nut rolling groove at the position where the rolling elements enter the nut rolling groove from the return path, and the nut rolling groove is higher than the return path at the position where the rolling elements enter the return path from the nut rolling groove.

The present invention has the following advantages:

The primary objective of the present invention is to provide a rolling element screw which can make the rolling elements pass the junctions where the rolling grooves are connected to the return paths smoothly without causing the jammed problem so as to improve the property of roller screws or ball screws.

### BRIEF DESCRIPTION OF THE DRAWINGS

FIG. 1 is a perspective view of a rolling element screw in accordance with the present invention;

FIG. 2 is an exploded view of the rolling element screw in accordance with the present invention;

FIG. 3 is a partial assembly view of the rolling element screw in accordance with the present invention;

FIG. 4 is a front assembly view of the rolling element screw in accordance with the present invention;

FIG. 5 is a front cross-sectional view illustrating how the rolling elements enter the return path from the nut rolling groove in accordance with the present invention;

FIG. 6 is a side cross-sectional view illustrating how the rolling elements enter the return path from the nut rolling groove in accordance with the present invention;

FIG. 7 is a front cross-sectional view illustrating how the rolling elements enter the nut rolling groove from the return path in accordance with the present invention;

FIG. 8 is a front cross-sectional view illustrating how the rolling elements enter the nut rolling groove from the return path in accordance with the present invention; and

FIG. 9 is a plane view illustrating how the rolling elements roll within the circulation path in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

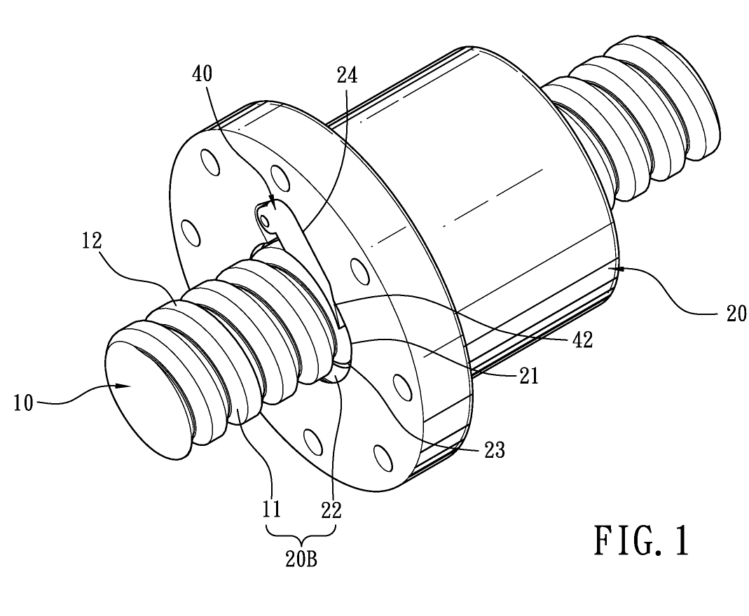

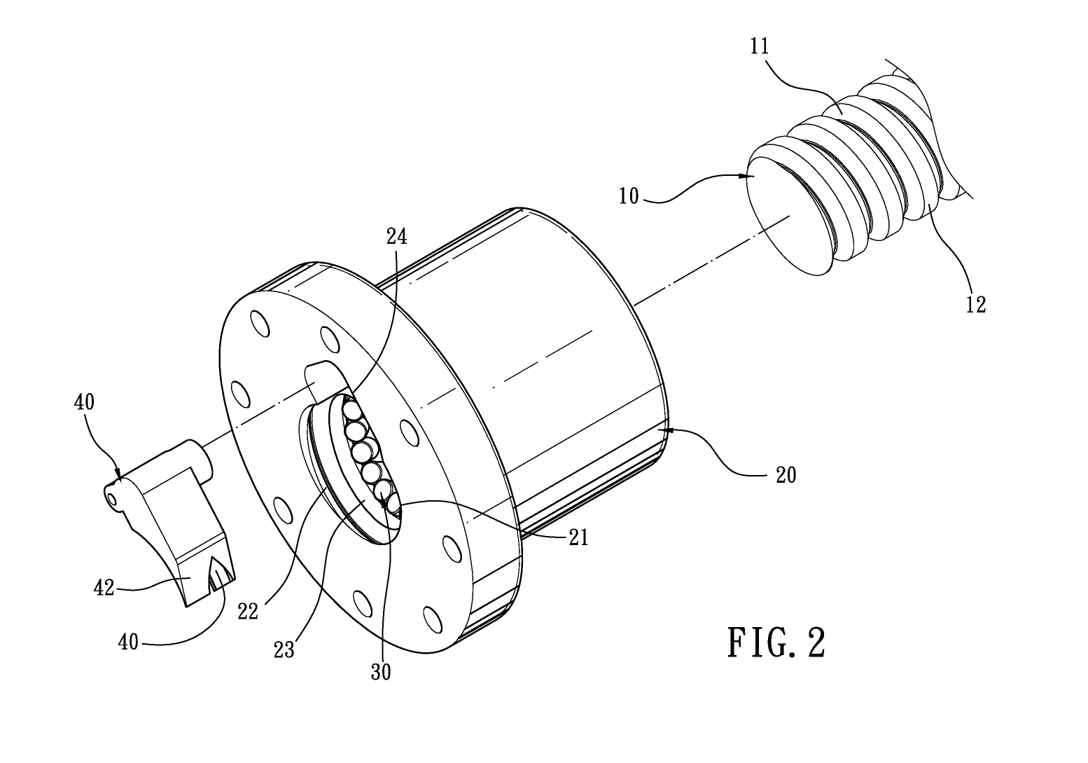

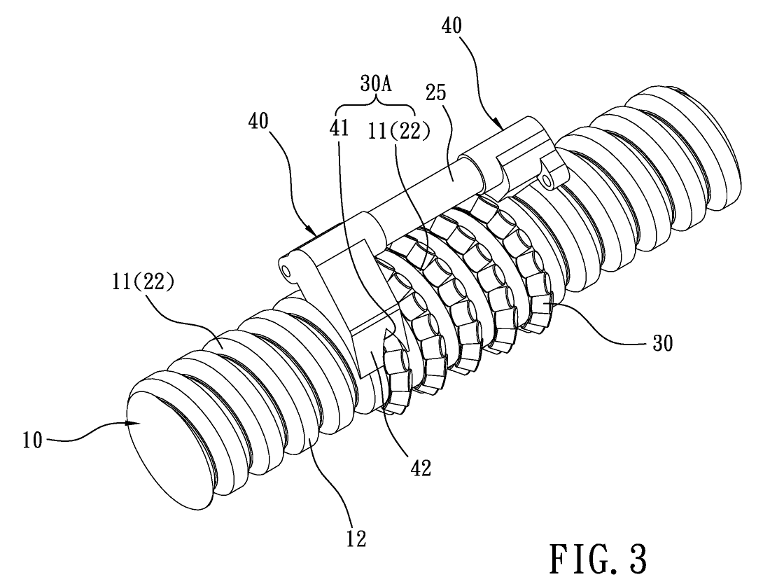

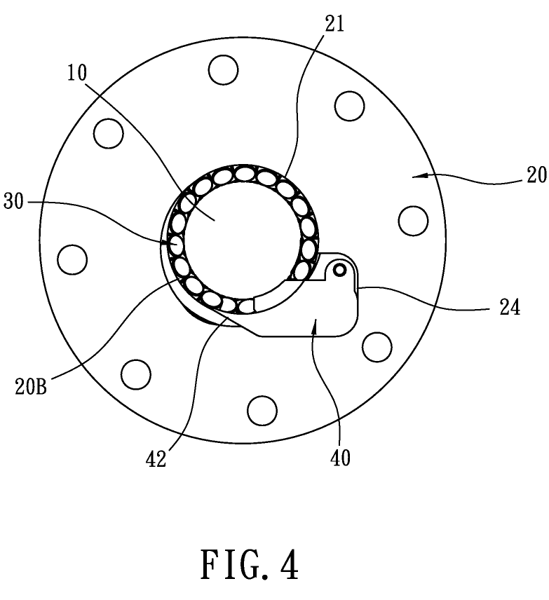

Referring to FIGS. 1-4, a rolling element screw in accordance with the present invention comprises a screw 10, a nut 20, plural rolling elements 30 and two return elements 40.

The screw 10 is provided with a screw rolling groove 11 in its periphery and a screw thread 12 defined by the screw rolling groove 11.

The nut 20 is defined with an insertion hole 21 for insertion of the screw 10, and provided with a nut rolling groove 22 in the inner surface of the insertion hole 21 and a nut thread 23 defined by the nut rolling groove 22. The nut rolling groove 22 is opposite the screw rolling groove 11. The screw rolling grove 11 and the nut rolling groove 22 cooperate with each other to define a loaded path 20B. The nut 20 is further defined with a recess 24 in each of two opposite ends thereof and a rolling passage 25 between the two recesses 24. The recesses 24 are connected to the loaded path 20, respectively.

The plural rolling elements 30 are rollably disposed in the loaded path 20B and in the form of a roller or a ball.

The two return elements 40 are installed in the recesses 24 of the nut 20, respectively. Each of the return elements 40 includes a return path 41. One end of the respective return paths 41 is connected to the loaded path 20B, and the other end of the respective return paths 41 is connected to each other, thus forming a circulation path 30A.

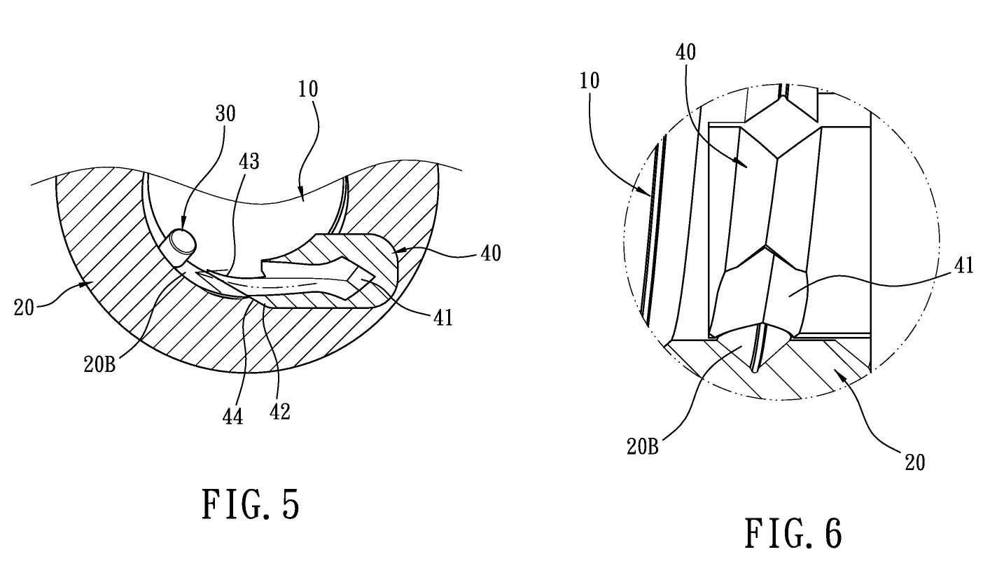

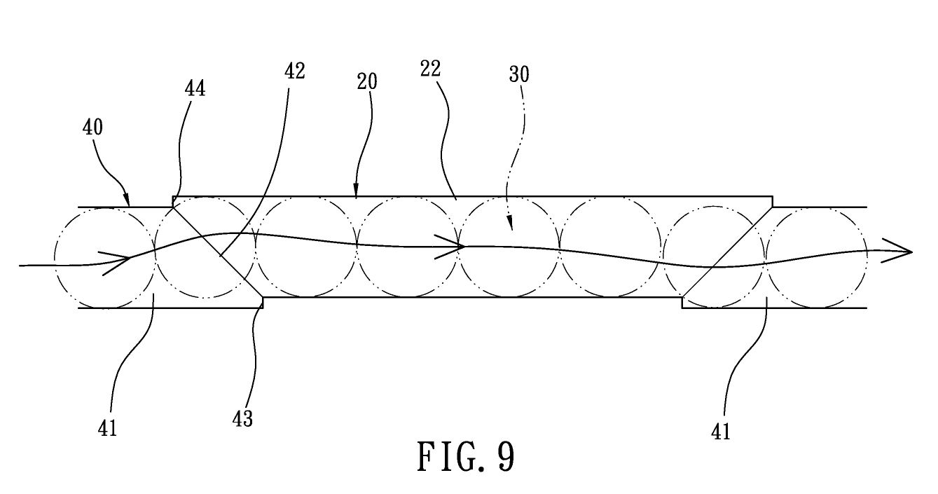

Referring to FIGS. 5-9, the junction where the nut rolling groove 22 is connected to the return path 41 is designed to be an inclined surface 42. The inclined surface 42 includes a lower portion 43 which is far away from the return element 40, and an upper portion 44 which is close to the return element 40. The lower portion 43 is the root of thread, and the upper portion 44 is the tip of thread. When entering the nut rolling groove 22 from the return path 41, the rolling elements 30 will pass the upper portion 44 first, and then pass the lower portion 43. When entering the return path 41 of the return element 40 from the nut rolling groove 22, the rolling elements 30 will pass the lower portion 43 first, and then pass the upper portion 44. The nut rolling groove 22 which is connected to the upper portion 44 and the lower portion 43 is higher than the return path 41, and an angle A defined between the recess 24 of the nut 20 and the inclined surface 42 of the return element 41 is an obtuse angle.

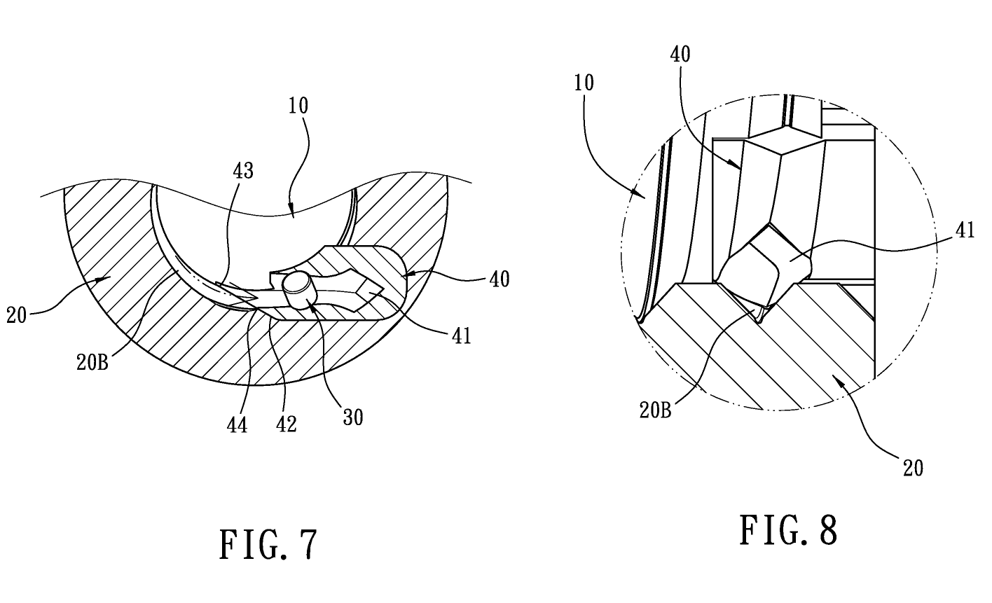

When the screw 10 rotates, the rolling elements 30 will be synchronously driven to roll within the circulation path 30A to make the nut 20 linearly move along the screw 10. When arriving at the distal end of the loaded path 20B, the rolling elements 30 will enter one of the return elements 40 and then roll out of the other of the return elements 40 to return to the start end of the loaded path 20B, thus completing a circulation. As shown in FIGS. 5-6 and FIG. 9, since the junction where the nut rolling groove 22 is connected to the return path 41 is designed to be the inclined surface 42, and the nut rolling groove 22 which is connected to the upper portion 44 and the lower portion 43 is higher than the return path 41, when entering the nut rolling groove 22 from the return path 41, the rolling elements 30 will move from low to high to contact the upper portion 44 first, and when contacting the lower portion 43, the rolling elements 30 will naturally lean toward the upper portion 44 and continue moving on to ensure a smooth passage. On the contrary, as shown in FIGS. 7-8 and FIG. 9, when entering the return path 41 from the nut rolling groove 22, the rolling elements 30 will contact the lower portion 43 first and then move from high to low, so that when contacting the upper portion 44, the rolling elements 30 will naturally lean toward the lower portion 43 and continue moving on to ensure a smooth passage. The screw 10 has a height difference effect no matter in clockwise rotation or counterclockwise rotation.

As known from the above specific embodiment of the present invention, the present invention has the following advantages: the junction where the return path 41 is connected to the nut rolling groove 22 is designed to be the inclined surface 42 which includes an upper portion 44 and a lower portion 43, and the nut rolling groove 22 which is connected to the upper portion 44 and the lower portion 43 is higher than the return path 41, so that when passing the inclined surface 42 and moving between the return path 41 and the nut rolling groove 22, the rolling elements 30 will move from high to low, thus ensuring the smooth passage of the rolling elements 30 without worrying about the jammed problem. As a result, the property of the roller screws or ball screws is improved.

While we have shown and described various embodiments in accordance with the present invention, it is clear to those skilled in the art that further embodiments may be made without departing from the scope of the present invention.

What is claimed is:

1. A rolling element screw comprising:
a screw being provided with a screw rolling groove in a periphery thereof;
a nut being provided with an insertion hole for insertion of the screw and a nut rolling groove in an inner surface of the insertion hole, the nut rolling groove being located opposite the screw rolling groove, so that the nut rolling groove cooperates with the screw rolling groove to define a loaded path, the nut being further provided with a recess in each of two opposite ends thereof and a rolling passage between the two recesses;
plural rolling elements being disposed in the loaded path;
two return elements being installed in the recesses of the nut, respectively, each of the two return elements including a return path, and one end of the respective return paths being connected to the loaded path, and the other end of the respective return paths being connected to each other, thus forming a circulation path;
a junction where the nut rolling groove is connected to the respective return paths of the return elements being designed to be an inclined surface including a lower portion and an upper portion, when entering the nut rolling groove from the return path which is higher than the nut rolling groove, the rolling elements will contact the lower portion of the inclined surface first, and when entering the return path from the nut rolling groove which is higher than the return path, the rolling elements will contact the upper portion of the inclined surface first, an angle between the inclined surface and the recess is an obtuse angle.

2. The rolling element screw as claimed in claim 1, wherein the rolling elements are balls.

3. The rolling element screw as claimed in claim 1, wherein the rolling elements are rollers.
